(19) United States
(12) Patent Application Publication
(10) Pub. No.: US 2001/0049900 A1
(43) Pub. Date: Dec. 13, 2001

(54) Glide bait lure

(76) Inventor: Paul R. Peck, Lola, WI (US)

Correspondence Address: Donald J. Ersler, 725 Garvens Avenue, Brookfield, WI, 53005, US

(21) Appl. No.: 09/832,675

(22) Filed: Apr. 11, 2001

Related U.S. Application Data
(63) Continuation-in-part of application No. 09/590,798, filed on Jun. 9, 2000.

(51) Int. Cl. A01K 85/00

(52) U.S. Cl. 43/42.39

(57) ABSTRACT

A glide bait lure includes a body, a substantially horizontal tail, at least one hook, and a line loop. The body has a fish like shape. A tapered area is formed on a top front portion of the body. A substantially horizontal tail extends from a rear of the body. The portion of the body below a horizontal center line is heavier than above the horizontal center line to prevent body roll. The line loop extends from a front of the body for attachment of a fishing line. Preferably, one treble hook is pivotally attached to a bottom of the body. The body is preferably painted to resemble a fish.

### CROSS-REFERENCE TO RELATED APPLICATIONS

This is a continuation-in-part application of Ser. No. 09/590,798 filed on Jun. 9, 2000.

### BACKGROUND OF THE INVENTION

1. Field of the Invention

The present invention relates generally to fishing lures and more specifically to a glide bait lure which moves in a horizontal zig-zag motion when the fishing rod is twitched downward during retrieval.

2. Discussion of the Prior Art

It is common for lures advertised as glide baits to rise (porpoise) when pulled. The natural angulation of the fishing line relative to the glide bait creates an additional, unwanted, upward force which makes the lure want to rise. Another problem with some prior art glide baits is the tapered shape of the tail; the tail of the glide bait is not hydrodynamically compensated to prevent porpoising. Once porpoising occurs, the lure loses stability and cannot glide in a zig-zag motion in a horizontal plane.

Accordingly, there is a clearly felt need in the art for a glide bait lure which is designed with a substantially horizontal tail, tapered head, and counter weight which forces thereof to zig-zag along a horizontal plane when pulled and not porpoise.

### SUMMARY OF THE INVENTION

The present invention provides a glide bait which is designed with compensation to ensure that thereof makes a zig-zag motion in a horizontal plane when the fishing rod is twitched downward. The glide bait lure includes a body, a substantially horizontal tail, at least one hook, and a line loop. The body has a fish like shape, such as a perch or a northern pike. The size of the body depends upon the type of fishing. A tapered area is preferably formed on a top front portion of the body. A substantially horizontal tail extends from a rear of the body.

The portion of the body below a horizontal center line is heavier than above the horizontal center line. The weight differential may be implement by use of at least one counter weight inserted into a bottom of the body. Alternatively, a hollow portion may be created above the horizontal center line. Other methods of creating a greater weight below the horizontal center line may also be used. The line loop extends from a front of the body for attachment of a fishing line. Preferably, one treble hook is pivotally attached to a bottom of the body at substantially a middle thereof and a second treble hook is attached to a bottom of the body at substantially a rear thereof. The body is preferably painted to resemble a fish.

Accordingly, it is an object of the present invention to provide a glide bait which has a substantially horizontal tail to compensate for the natural forces of porpoising when pulled.

It is a further object of the present invention to provide a glide bait which has a tapered front to compensate for the natural forces of porpoising when pulled.

Finally, it is another object of the present invention to provide a glide bait which is weight compensated to prevent body roll.

These and additional objects, advantages, features and benefits of the present invention will become apparent from the following specification.

### BRIEF DESCRIPTION OF THE DRAWINGS

FIG. 1 is a front perspective view of a glide bait lure in accordance with the present invention.

FIG. 2 is a side view of a glide bait lure in accordance with the present invention.

FIG. 2a is a side cross sectional view of an alternative weighing scheme of a glide bait lure in accordance with the present invention.

FIG. 3 is a top view of a glide bait lure in accordance with the present invention.

FIG. 4 is a front view of a glide bait lure in accordance with the present invention.

FIG. 5 is a rear view of a glide bait lure in accordance with the present invention.

FIG. 6 is a side view of a glide bait lure being pulled through the water in a horizontal orientation in accordance with the present invention.

FIG. 7 is a top view of a glide bait lure being pulled through the water when a fishing rod is twitched downward in in accordance with the present invention.

### DETAILED DESCRIPTION OF THE PREFERRED EMBODIMENTS

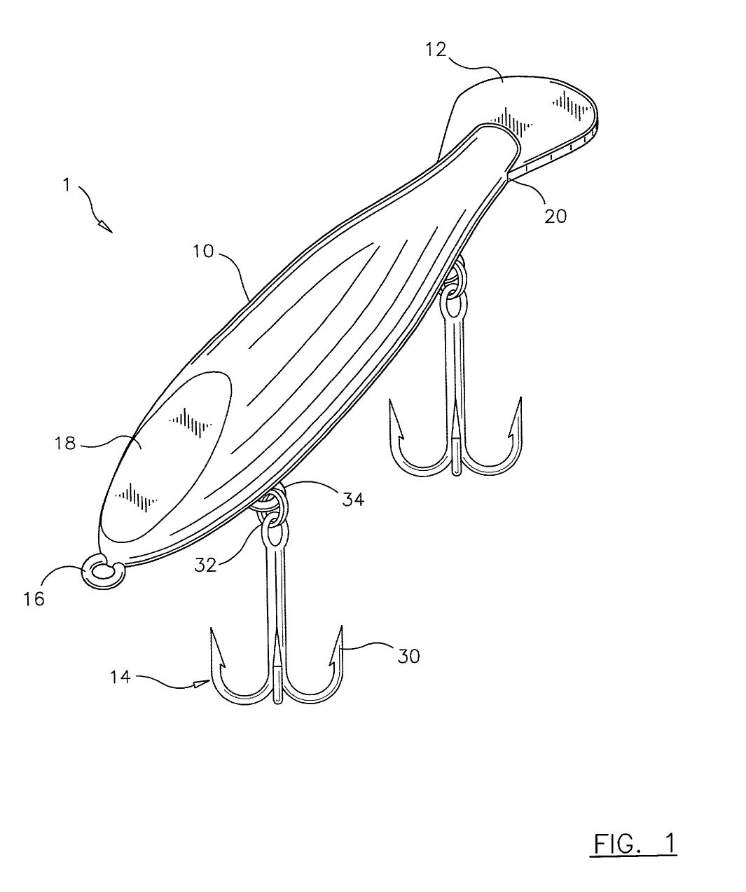

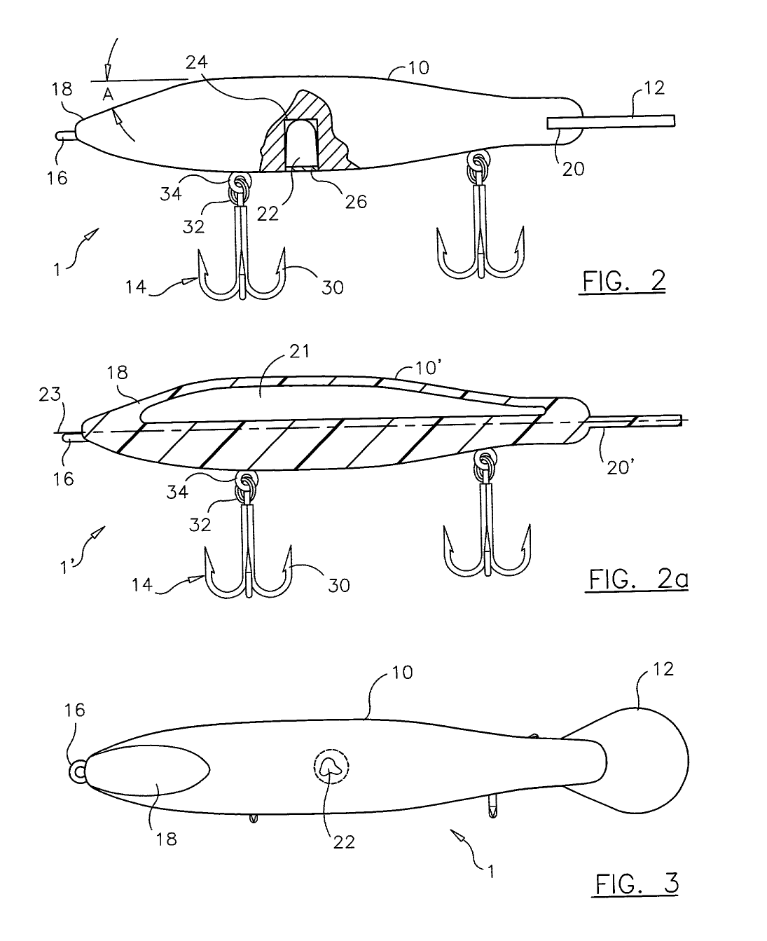

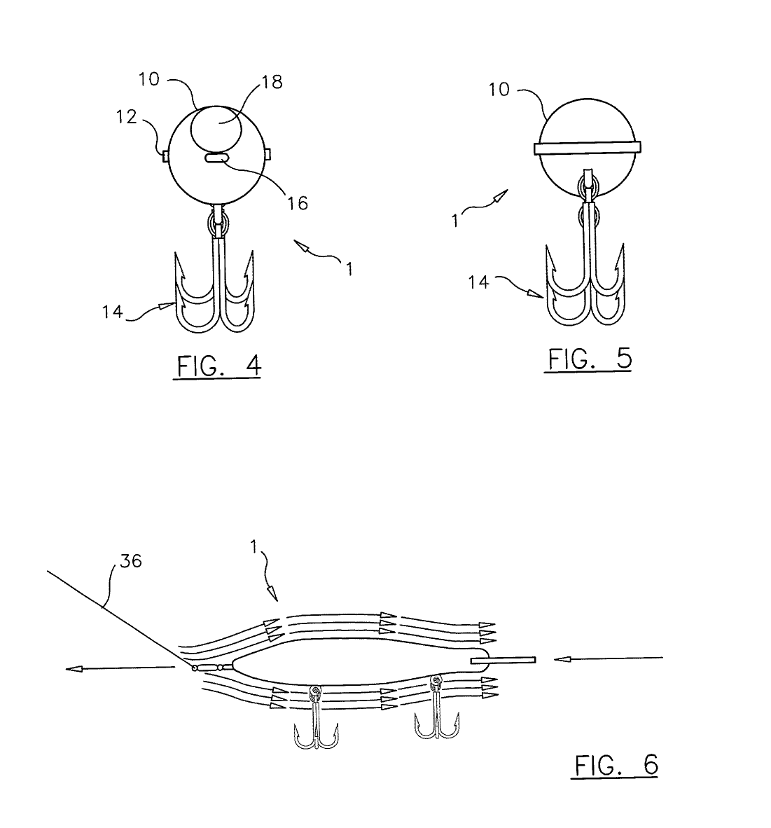

With reference now to the drawings, and particularly to FIG. 1, there is shown a front perspective view of a glide bait lure 1. With reference to FIGS. 2 and 3, the glide bait lure 1 includes a body 10, a substantially horizontal tail 12, at least one hook 14, and a line loop 16. The body 10 has a fish like shape, such as a perch or a northern pike. The size of the body depends upon the type of fishing or type of fish to be caught. The body 10 is preferably fabricated from molded plastic. The body 10 is preferably painted to resemble some type of fish. A tapered area 18 is formed on a top front portion of the body 10. The angle “A” of the tapered area 18 may vary between 5-34 degrees. Satisfactory operation occurs when the angle “A” has a value of 18 degrees. The tapered area 18 preferably originates on the front of the body 10 at and continues back. The tapered area 18 causes the front of the body 10 to be pushed downward to compensate for the natural tendency of the body 10 to rise when pulled through the water by an angled fishing line 36 as shown in FIG. 6.

A substantially horizontal tail 12 extends from a rear of the body 10. A slot 20 is preferably formed in a rear of the body 10 that is sized to receive the substantially horizontal tail 12. The substantially horizontal tail 12 is preferably fastened in the slot 20 with an adhesive, but could be fastened with any other suitable assembly method. The tail 12 and the body 10 could also be fabricated from a single piece of material as shown in FIG. 2a. The orientation of the substantially horizontal tail 12 compensates for the natural tendency of the body 10 to rise when pulled through the water. The substantially horizontal tail 12 is rigid and preferably fabricated from a clear or translucent plastic, but could also be fabricated from some other material such as a metal.

The portion of the body 10 below a horizontal center line 23 is heavier than above the horizontal center line 23. The weight differential may be implemented by use of at least one counter weight 22 inserted into a bottom of the body 10. A cavity 24 is formed in a bottom of the body 10 at preferably a middle thereof for insertion of a single counter weight 22. A rear of each counter weight 22 is preferably covered with a filler material 26 for cosmetic purposes. The at least one counter weight 22 prevents the body 10 from rolling about its longitudinal axis when pulled through water. FIG. 2a shows a cross sectional view of a glide bait lure 1′. A hollow portion 21 may be created above the horizontal center line 23 to make the body 10′ heavier below the horizontal center line 23 than above it. The line loop 28 extends from a front of the body 10 for attachment of a fishing line 36. A small eye screw may be used for the line loop 28. Other devices may also be used for attaching a fishing line 36 to the body 10.

The at least one hook 14 preferably includes a treble hook 30, a connection ring 32, and a ring loop 34. One ring loop 34 is fastened to a bottom of the body 10 at substantially a middle thereof and a second ring loop 34 is fastened to a bottom of the body 10 at substantially a rear thereof. A single connection ring 32 is inserted through an eye of each treble hook 30 and each ring loop 34. The connection ring 32 retains the treble hook 30 relative to the ring loop 34 and also enables the treble hook 30 to swivel relative to the ring loop 34. A split ring may be used for the connection ring 32. A small eye screw may be used for the ring loop 34. Other devices may also be used instead the split ring and the small eye screw.

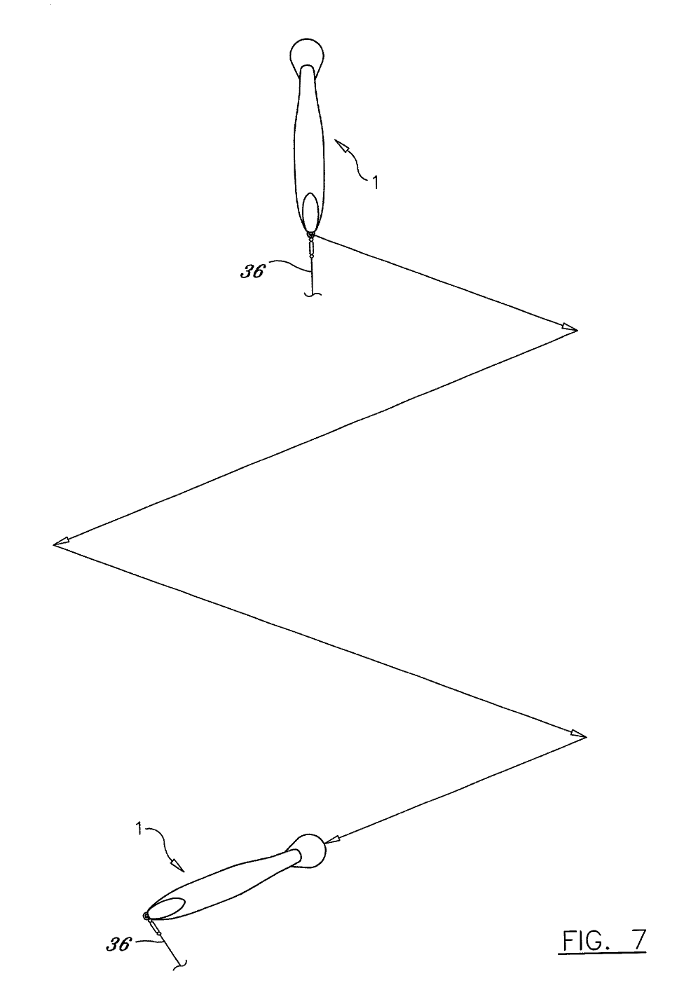

In FIG. 6, the glide bait lure 1 travels through the water in a horizontal plane even though the fishing line 36 is not parallel with the horizontal path. FIG. 7 shows the zig-zag motion of the glide bait lure 1 in a horizontal plane when the fishing rod is twitched in a downward motion. The glide bait lure 1 zig-zags side to side, yet retains in a horizontal plane when the fishing line rod is twitched in a downward motion.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A glide bait lure comprising:
a body having a fish like shape, said body having a front and a rear;
a substantially horizontal tail extending from a rear of said body;
a tapered area formed on a front of said body;
at least one hook extending from a bottom of said body;
said body being heavier below a horizontal center line than above thereof; and
a line loop extending from a front of said body for the attachment of a fishing line.

2. The glide bait lure of claim 1 wherein:
each said hook including a treble hook, connection ring, and a ring loop, said ring loop being fastened to a bottom of said body, a single connection ring being inserted through an eye of said treble hook and said ring loop.

3. The glide bait lure of claim 1 wherein:
said substantially horizontal tail being fastened inside a slot formed in a rear of said body.

4. The glide bait lure of claim 1 wherein:
at least one counter weight inserted into a bottom of said body at substantially thereof.

5. The glide bait lure of claim 1 wherein:
a hollow portion being formed in said body above said horizontal center line.

6. The glide bait lure of claim 1 wherein:
said substantially horizontal tail having a color which is clear or translucent.

7. A glide bait lure comprising:
a body having a fish like shape, said body having a front and a rear;
a substantially horizontal tail extending from a rear of said body, said substantially horizontal tail being rigid;
said body being heavier below a horizontal center line than above thereof; and
at least one hook extending from a bottom of said body.

8. The glide bait lure of claim 7 wherein:
a tapered area being formed on a front of said body.

9. The glide bait lure of claim 7, further comprising:
at least one counter weight being inserted into a bottom of said body.

10. The glide bait lure of claim 7, further comprising:
a hollow portion being formed in said body above said horizontal center line.

11. The glide bait lure of claim 7, further comprising:
a line loop extending from a front of said body for the attachment of a fishing line.

12. The glide bait lure of claim 7 wherein:
each said hook including a treble hook, connection ring, and a ring loop, said ring loop being fastened to a bottom of said body, a single connection ring being inserted through an eye of said treble hook and said ring loop.

13. The glide bait lure of claim 7 wherein:
said substantially horizontal tail being fastened inside a slot formed in a rear of said body.

14. The glide bait lure of claim 7 wherein:
said substantially horizontal tail having a color which is clear or translucent.

15. A glide bait lure comprising:
a body having a fish like shape, said body having a front and a rear, a tapered area being formed on a front of said body;
said body being heavier below a horizontal center line than above thereof; and
at least one hook extending from a bottom of said body.

16. The glide bait lure of claim 15, further comprising:
a substantially horizontal tail extending from a rear of said body.

17. The glide bait lure of claim 16 wherein:
said substantially horizontal tail being fastened inside a slot formed in a rear of said body.

18. The glide bait lure of claim 16 wherein:
said substantially horizontal tail having a color which is clear or translucent.

19. The glide bait lure of claim 15, further comprising:
at least one counter weight being inserted into a bottom of said body at substantially a middle thereof.

20. The glide bait lure of claim 15, further comprising:
a hollow portion being formed in said body above said horizontal center line.

21. The glide bait lure of claim 15, further comprising:
a line loop extending from a front of said body for the attachment of a fishing line.

22. The glide bait lure of claim 15 wherein:
each said hook including a treble hook, connection ring, and a ring loop, said ring loop being fastened to a bottom of said body, a single connection ring being inserted through an eye of said treble hook and said ring loop.

23. A method of making a glide bait lure travel through the water in a horizontal plane even though the fishing line is not parallel with the horizontal path comprising the steps of:
(a) providing a body having a fish like shape, said body having a front and rear;
(b) forming a substantially horizontal tail on a rear thereof; and
(c) extending at least one hook extending from a bottom of said body.

24. The method of making a glide bait lure travel through the water in a horizontal plane even though the fishing line is no parallel with the horizontal path of claim 23 wherein:
said substantially horizontal tail being rigid.

25. The method of making a glide bait lure travel through the water in a horizontal plane even though the fishing line is no parallel with the horizontal path of claim 23 wherein:
a tapered area being formed on a front of said body.

26. The method of making a glide bait lure travel through the water in a horizontal plane even though the fishing line is no parallel with the horizontal path of claim 23, further comprising:
at least one counter weight being inserted into a bottom of said body.

27. The method of making a glide bait lure travel through the water in a horizontal plane even though the fishing line is no parallel with the horizontal path of claim 23 wherein:
a hollow portion being formed in said body above said horizontal center line.

28. The method of making a glide bait lure travel through the water in a horizontal plane even though the fishing line is no parallel with the horizontal path of claim 23, further comprising:
a line loop extending from a front of said body for the attachment of a fishing line.

29. The method of making a glide bait lure travel through the water in a horizontal plane even though the fishing line is no parallel with the horizontal path of claim 23, further comprising:
each said hook including a treble hook, connection ring, and a ring loop, said ring loop being fastened to a bottom of said body, a single connection ring being inserted through an eye of said treble hook and said ring loop.

30. The method of making a glide bait lure travel through the water in a horizontal plane even though the fishing line is no parallel with the horizontal path of claim 23 wherein:
said substantially horizontal tail having a color which is clear or translucent.
